(19) United States
(12) Patent Application Publication
(10) Pub. No.: US 2026/0144237 A1
(43) Pub. Date: May 28, 2026

(54) COMBINED HABITAT PLATFORM FOR RAPIDLY CONSTRUCTING BIRD MICROHABITAT

(71) Applicant: Institute of Zoology, Guangdong Academy of Sciences, Guangzhou (CN)

(72) Inventors: Huijian HU, Guangzhou (CN); Yuanzhihong LIU, Guangzhou (CN); Xiqing LIU, Guangzhou (CN); Xiaoshan FANG, Guangzhou (CN); Zhouhan CHEN, Guangzhou (CN); Junyu WANG, Guangzhou (CN)

(73) Assignee: Institute of Zoology, Guangdong Academy of Sciences, Guangzhou, GD (CN)

(21) Appl. No.: 19/389,037

(22) Filed: Nov. 14, 2025

(30) Foreign Application Priority Data
Nov. 22, 2024 (CN) 202411678066.6

(51) Int. Cl. A01K 45/00

(52) U.S. Cl. CPC A01K 45/00

(57) ABSTRACT

A combined habitat platform for rapidly constructing a bird microhabitat is provided, and relates to the technical fields of wetland ecology repair technologies and wetland biodiversity restoration. The platform includes a plurality of habitat platform units with different immersion heights. Each of the habitat platform units includes several main body splicing units, buoyant units, and a vegetation layer paved on the main body splicing unit. According to the present disclosure, an enclosed platform formed by combining the buoyant units and the main body splicing units can not only load soil to support the vegetation layer as various plants planted for constructing the bird microhabitat, but also provide high-degree-of-freedom space for constructing a habitat and a foraging environment for wetland animals such as birds, so as to construct a stable ecosystem with integration on the water and under the water, a complete food chain, and abundant biodiversity, and provide a suitable habitat for wetland organisms such as birds, thereby effectively promoting restoration of integrity and stability of the wetland ecosystem.

The present application claims the priority of Chinese patent application No. 202411678066.6, filed 2024-11-22, the entire disclosure of which Chinese application is incorporated herein by reference.

### TECHNICAL FIELD

The present disclosure relates to the technical field of wetland ecology repair technologies and wetland biodiversity restoration, in particular to a combined habitat platform for rapidly constructing a bird microhabitat.

### BACKGROUND

As medium and advanced consumers in food chains, birds that are highly sensitive to environmental changes are important indicator species in ecosystems, and are also important components of urban ecosystems. However, with the rapid development of urbanization, a large quantity of natural waterfront areas are hardened, verticalized and artificialized, withering and fragmentation problems of bird habitats are increasingly serious, resulting in decrease in bird diversity and population quantity. The current construction projects of water bank restoration and bird habitat often require a large number of landfills to restore the gradient structures of natural water banks, which are slow in time and high in costs, and are severely restricted in the water source protection area. Therefore, there is an urgent need for a rapid and low-cost technical method for constructing a waterfront bird habitat.

Birds have specific needs for habitats, including food sources, shelter and breeding places. At present, floating facilities for bird habitats in water are divided into two types: One type is traditional floating facilities. Although materials are simple and easy to make, the structure and function are single, the service life is short, it is difficult for the facilities to maintain bird habitat environment for a long time, and the facilities cannot be put into production practice on a large scale. The other type is novel artificial floating islands. Compared with a traditional floating facility, the floating island has a complex structure and multiple functions. However, the floating island is often limited by use scenarios, is not applicable widely, and relatively high in costs.

As a method for rapidly constructing green plant areas on water, an ecological floating island is widely used in terms of water purification and landscaping. The ecological floating island is small in occupied area, simple in operation, and significant in purification effect, and can significantly improve water transparency and restore a water ecosystem, thereby providing a suitable place for birds and aquatic plants to proliferate. However, existing ecological floating islands still have limitations in terms of bird habitat construction and biodiversity restoration.

Specifically, some ecological floating islands lack enough stability, and are susceptible to natural factors such as wind and wave. Some floating islands lack reasonable vegetation configuration and animal introduction strategies, resulting in poor biodiversity restoration. Some floating islands cannot sustain plant growth for a long time, resulting in a gradual decline in functions. These problems limit the application effects of ecological floating islands in the terms of bird habitat construction and biodiversity restoration.

In order to protect and repair the bird habitat, the bird habitat and the active area on the water surface may be expanded by using a combined ecological floating island, so as to solve the foregoing problem. The combined ecological floating island has more advantages than a traditional ecological floating island. The combined ecological floating islands can be combined flexibly according to different water environment and bird habitat requirements to realize multiple functions and customization. By adjusting the size, shape and plant configuration of the floating island, a more suitable ecological environment for birds can be created. In addition, the combined ecological floating island is easy to install and maintain, thereby reducing construction and operation costs.

The existing combined ecological floating island technology has a relatively single function in the field of wetland ecological restoration and biodiversity restoration, and is generally an application of short-term quantity restoration for a specific species. There are no cases of sustainable ecological restoration and biodiversity restoration by creating a complete micro-ecosystem. In the prior art, floating island combinations of different immersion depths are not fully used to construct a gradient habitat, so as to meet different foraging water depth requirements of different types of water birds, and further enrich the spatial layer of the bird microhabitat. Therefore, there is an urgent need for a combined habitat platform that can rapidly construct a bird microhabitat and has high flexibility and stability, so as to promote effective restoration of wetland ecosystem integrity and stability.

### SUMMARY

In view of the existing technical problems, the present disclosure provides a combined habitat platform for rapidly constructing a bird microhabitat.

The technical solution of the present disclosure is as follows. A combined habitat platform for rapidly constructing a bird microhabitat is provided. The platform includes a plurality of habitat platform units. Each of the habitat platform units includes several mutually connected main body splicing units, buoyant units disposed on outer sidewalls of the main body splicing units, fixed bolts configured to connect the main body splicing units and the buoyant units, and a vegetation layer disposed on upper end faces of the main body splicing units;
the main body splicing unit includes a square frame and several buoyant columns equally distributed inside the square frame; lug structures are disposed at four corner positions of the square frame, and a mounting hole runs through each of the lug structures;
the buoyancy unit includes first buoyancy modules disposed on sides of the square frame and second buoyancy modules disposed at four corner positions of the square frame; both ends of the first buoyancy module are provided with the lug structures, and the second buoyancy module is also provided with the lug structures; the lug structures on the adjacent square frame, first buoyancy module and second buoyancy modules overlap with one another, and the mutually overlapped lug structures are connected and fixed by using the fixed bolts; a water injection pipe is disposed on an upper end face of each of the first buoyancy modules, and a drain pipe is disposed on a lower bottom face of each of the first buoyancy modules; and
the vegetation layer includes a cushion layer paved on the upper end faces of the main body splicing units, a substrate paved above the cushion layer, and plants planted on the substrate.

Further, hexagonal holes are disposed inside the lug structure and formed in upper and lower ends of the mounting hole; the fixed bolt includes a round table and a first screw disposed on a lower bottom face of the round table; and a limit protrusion that is able to be movably engaged with the hexagonal hole is disposed on an outer sidewall of the round table.

Description: After the first screw is inserted into the mounting holes in the lug structures stacked together with each other, the limit protrusion on the outer sidewall of the round table can be engaged with the hexagonal hole on the lug structure, so as to avoid rotation of the first screw during fastening.

Further, a gasket sleeved on the first screw at a corresponding position is disposed between two adjacent lug structures; and a communication hole runs through the gasket, and hexagonal bosses that are able to be movably engaged with the hexagonal holes are disposed on the gasket and located at upper and lower ends of the communication hole.

Description: A height difference between the main body splicing unit and the buoyant unit can be adjusted by using interactive engagement between the hexagonal boss on the gasket and the hexagonal holes in two adjacent lug structures.

Further, an annular groove is formed in each of the buoyant columns.

Description: the annular groove is formed in the buoyant column, so that a zigzag gap is formed between two adjacent buoyant columns, and a root of an aquatic plant can be grown through the gap, thereby establishing a close relation between the vegetation layer and a water environment, and enhancing stability and durability of the platform by using the main body splicing units twined on a root system.

Further, a first sawtooth portion is circumferentially disposed on an outer sidewall of the square frame, and a second sawtooth portion that is able to be movably engaged with the first sawtooth portion is disposed on an inner sidewall of the first buoyancy module; and third sawtooth portions are disposed at both ends of the first buoyancy module, and fourth sawtooth portions that are able to be movably engaged with the third sawtooth portions are disposed at both ends of the second buoyancy module.

Description: The connection strength between the square frame and the first buoyancy module can be improved by using an engaging action between the first sawtooth portion and the second sawtooth portion. By using an engaging action between the third sawtooth portion and the fourth sawtooth portion, the connection stability and attractive appearance between the first buoyancy module and the second buoyancy module are improved.

Further, a rod-shaped joint is disposed on a lower bottom face of each of the square frames.

Description: By setting the square frame is disposed, the connection between the main body splicing unit and an ecological units such as an underwater artificial fish reef is facilitated.

Further, each of the lug structures is respectively slidably engaged with the square frame, the first buoyancy module, and the second buoyancy module at corresponding positions by using sliding guide rods; a first clamping groove is disposed on a sidewall of the square frame; a second clamping groove is disposed on a sidewall of the first buoyancy module, and an H-shaped retainer is movably clamped between the first clamping groove and the second clamping groove at corresponding positions for clamping; and the H-shaped retainer is respectively fixedly connected to the first clamping groove and the second clamping groove by using second screws.

Description: By setting the H-shaped retainer, the connection stability between the main body splicing unit and the buoyant unit can be improved, so that when the platform is used in a bad environment, the torsion at a joint between the lug structure and the square frame is too large, resulting in deformation and detachment of the lug structure.

A mounting method in the present disclosure includes the following steps:
S1: Assembling main body splicing units.

A plurality of main body splicing units are arranged according to a predetermined layout, and are connected to fixed bolts by using lug structures on the main body splicing units. A first screw passes through a mounting hole in the lug structure of the adjacent main body splicing unit, and is tightened by using a nut, so as to ensure a stable connection between the main body splicing units.
S2: Adjusting a height and splicing buoyant units.

A gasket is placed on the lug structure of the main body splicing unit, and the height of the gasket is adjusted according to requirements, so as to ensure that each lug structure of the main body splicing unit is at a same height, and then a left lug structure of a first buoyancy module is superposed on the lug structure of the main body splicing unit, and finally, a screw is used to sequentially pass through a mounting hole of each lug structure and is tightened with a nut. A lug structure on a second buoyancy module is superposed on a lug structure of the first buoyancy module, and finally, a screw sequentially passes through mounting holes in each lug structure and is tightened with a nut. The foregoing steps form a habitat platform unit.
S3: Placing the habitat platform unit, paving a vegetation layer, and adjusting an immersion depth.

An appropriate placement location is selected, the assembled habitat platform unit is placed in a predetermined water area, and then a vegetation layer is paved on the main body splicing unit. The steps sequentially include laying a cushion layer and filling a substrate, planting hygrophytes, covering sand stone, placing a dead wood heap and a stone heap. The immersion depth of the habitat platform unit is adjusted according to requirements by using a water injection port and a drain port of the buoyant unit.
S4: Fixing the habitat platform.

The habitat platform is fixed to the water surface in an anchoring manner, and two 50 kg iron anchors are connected to the main body splicing units 1 at both ends of the habitat platform, where a used anchor rope used has a length three times as long as a water depth. Or, the habitat platform is fixed on the water surface in a water piling manner, which is suitable for near-shore shallow water areas with the water depth of less than 3-5 meters.
S5: Performing repeated splicing and gradient combination to form a complete habitat platform.

According to requirements, step S1-4 are repeated to assemble the habitat platform units of different immersion depths, and then the habitat platform units of different immersion depths are combined to form a larger-scale and complete combined habitat platform.

Compared with the prior art, the present disclosure has the following beneficial effects.

Firstly, according to the present disclosure, the form and the ecological function of a natural island are simulated by means of ingenious platform structure design, cushion layer and substrate optimization, reasonable plant configuration and planting density, immersion depth adjustment, and other manners, so as to create various habitats suitable for resting, foraging, hiding, and nesting of water birds and amphibians.

Secondly, according to the present disclosure, the platforms can be quickly constructed and flexibly combined to meet environment and ecological requirements of different waters, thereby greatly improving the efficiency of bird microhabitat construction in wetland ecological restoration projects.

Thirdly, according to the present disclosure, a curved gap is formed between the buoyant columns. The gap may provide space for growth of a plant root system. After the plant root system is grown through the gap, a close relation between the vegetation layer and a water environment is established, and the main body splicing unit is wound around the root system, thereby enhancing the stability and durability of the platform.

Fourthly, according to the present disclosure, the buoyant unit has an adjustable water injection function. By changing the water injection rate, the immersion depth of the floating island can be flexibly adjusted to form a gradient habitat, which meets different foraging immersion requirements of different types of water birds, further enriches the spatial layer of the bird microhabitat, and improves a protection level of wetland biodiversity.

Fifthly, according to the present disclosure, a columnar joint is disposed at the bottom of the main body splicing unit, so as to facilitate connection with an ecological unit such as an underwater artificial fish reef, construct a stable ecosystem with integrity on the water and under the water, complete food chain, and abundant biodiversity, and provide a more suitable habitat for wetland organisms such as birds, thereby effectively promoting restoration of integrity and stability of the wetland ecosystem.

### BRIEF DESCRIPTION OF THE DRAWINGS

FIG. 1 is a structural schematic diagram according to the present disclosure;

FIG. 2 is a structural schematic diagram of a habitat platform unit according to the present disclosure;

FIG. 3 is a connection schematic diagram of a main body splicing unit and a buoyant unit according to the present disclosure;

FIG. 4 is a connection schematic diagram of a communication pipe and a habitat platform unit according to the present disclosure;

FIG. 5 is a structural schematic diagram of a main body splicing unit according to the present disclosure;

FIG. 6 is a distribution diagram of a rod-shaped joint on a square frame according to the present disclosure;

FIG. 7 is a structural schematic diagram of a first buoyancy module according to the present disclosure;

FIG. 8 is a structural schematic diagram of a second buoyancy module according to the present disclosure;

FIG. 9 is a structural schematic diagram of a fixed bolt according to the present disclosure;

FIG. 10 is a structural schematic diagram of a gasket according to the present disclosure; and

FIG. 11 is a connection schematic diagram of an H-shaped retainer, a square frame, and a first buoyancy module according to the present disclosure.

Reference numerals: 1: main body splicing unit; 10: square frame; 100: rod-shaped joint; 101: first clamping groove; 11: buoyant column; 110: annular groove; 12: lug structure; 120: mounting hole; 121: hexagonal hole; 122: guide rod; 13: first sawtooth portion; 2: buoyant unit; 20: first buoyancy module; 200: water injection pipe; 201: drain pipe; 202: second sawtooth portion; 203: third sawtooth portion; 204: second clamping groove; 21: second buoyancy module; 210: fourth sawtooth portion; 22: communication pipe; 3: fixed bolt; 30: round table; 300: limit protrusion; 31: first screw; 4: gasket; 40: communication hole; 41: hexagonal boss; 5: H-shaped retainer; 50: second screw; and 6: fence structure.

### DETAILED DESCRIPTION OF THE EMBODIMENTS

### Embodiment 1

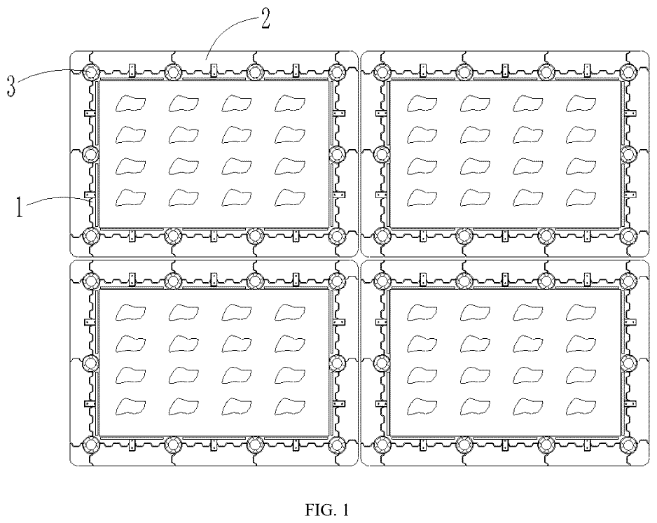

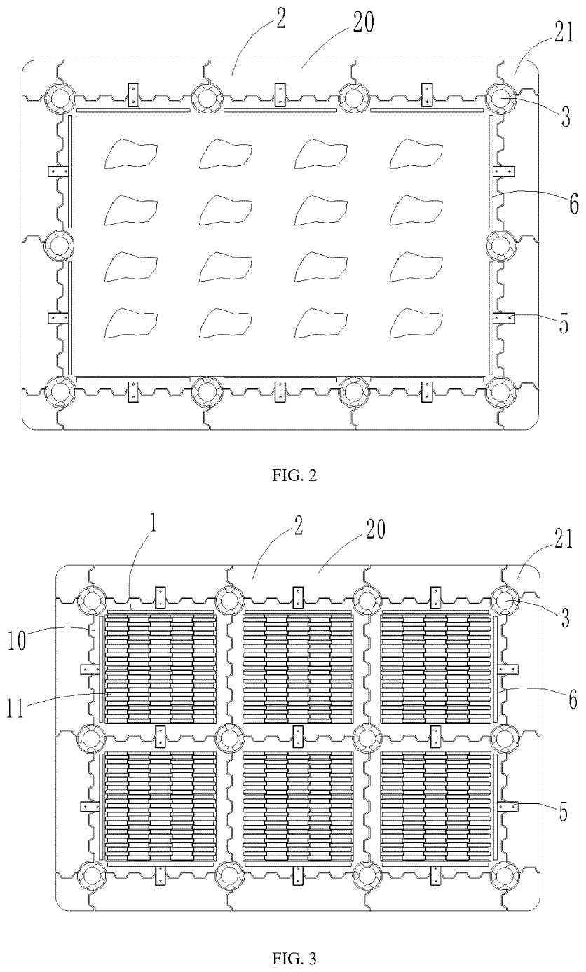

As shown in FIG. 1, FIG. 2, and FIG. 3, a combined habitat platform for rapidly constructing a bird microhabitat is provided. The platform includes four habitat platform units. Each of the habitat platform units includes six mutually connected main body splicing units 1, buoyant units 2 disposed on outer sidewalls of the main body splicing units 1, fixed bolts 3 configured to connect the main body splicing units 1 and the buoyant units 2, and a vegetation layer disposed on upper end faces of the main body splicing units 1.

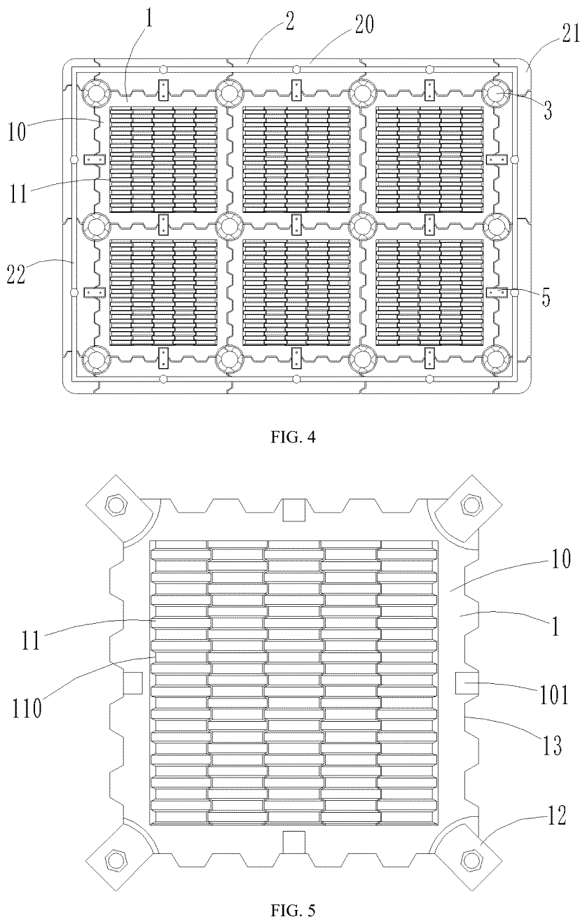

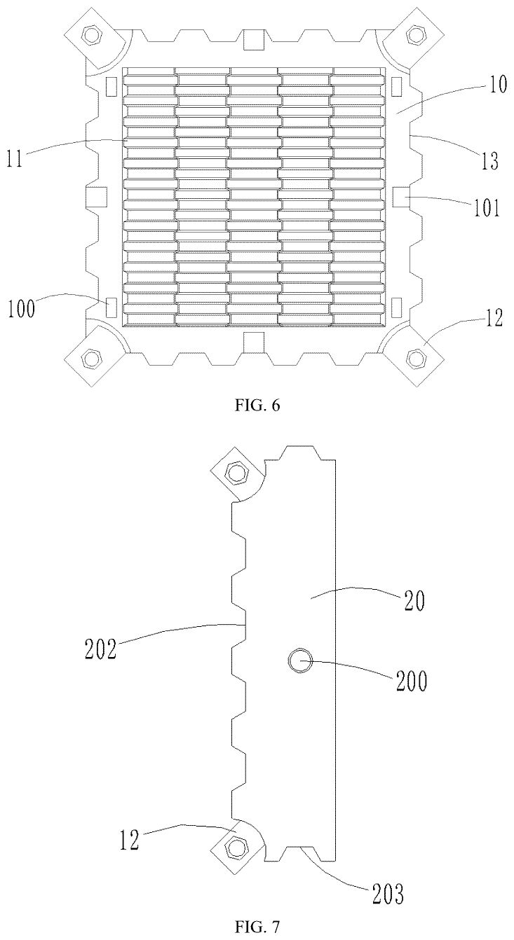

As shown in FIG. 4, FIG. 5, FIG. 6, and FIG. 7, the main body splicing unit 1 includes a square frame 10 and five buoyant columns 11 equally distributed inside the square frame 10. A rod-shaped joint 100 is disposed on a lower bottom face of each of the square frames 10. Lug structures 12 are disposed at four corner positions of the square frame 10, and a mounting hole 120 runs through each of the lug structures 12. An annular groove 110 is formed in each of the buoyant columns 11.

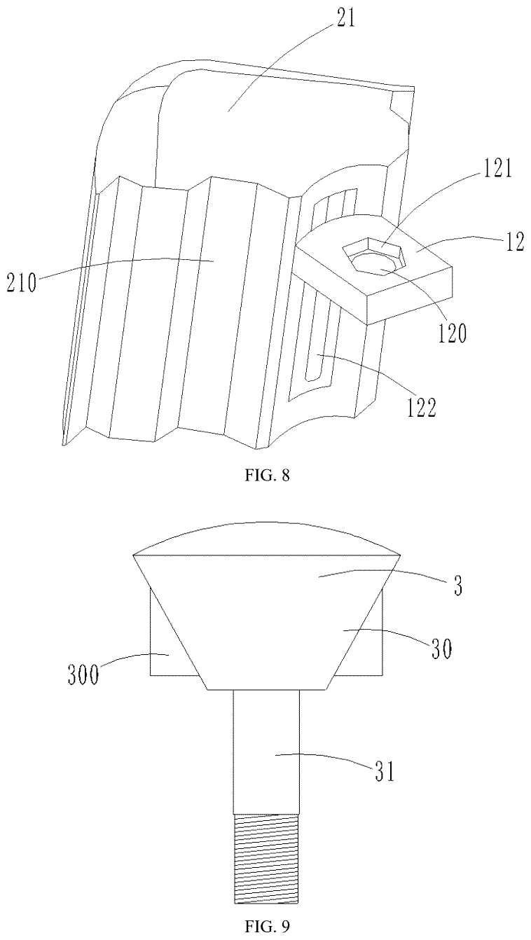

As shown in FIG. 3, FIG. 7, FIG. 8, and FIG. 11, the buoyancy unit 2 includes first buoyancy modules 20 disposed on sides of the square frame 10 and second buoyancy modules 21 disposed at four corner positions of the square frame 10. Both ends of the first buoyancy module 20 are provided with the lug structures 12, and the second buoyancy module 21 is also provided with the lug structures 12. The lug structures 12 on the adjacent square frame 10, first buoyancy module 20 and second buoyancy modules 21 overlap with one another, and the mutually overlapped lug structures 12 are connected and fixed by using the fixed bolts 3. A water injection pipe 200 is disposed on an upper end face of each of the first buoyancy modules 20, and a drain pipe 201 is disposed on a lower bottom face of each of the first buoyancy modules 20.

As shown in FIG. 2, the vegetation layer includes a cushion layer on upper end faces of the main body splicing units 1, a substrate paved above the cushion layer, and plants planted on the substrate. The cushion layer includes geotextile cloth and a shading net, first the shading net is paved, and then the geotextile is paved. The substrate is planting soil which is filled in a manner that the planting soil is thick in the middle and thin in the surroundings. The plants include: Variegated Giant Reed, Alligator Flag, Cattail, Common Reed, Canna Lily, Purple Loosestrife, Pickerelweed, Iris, Creeping Jenny, Sheathed Monochoria, Purslane, Knotweed, and Lawn Pennywort.

### Embodiment 2

Differences between this embodiment and Embodiment 1 are as follows.

As shown in FIG. 8 and FIG. 9, hexagonal holes 121 are disposed inside the lug structure 121 and formed in upper and lower ends of the mounting hole 120. The fixed bolt 3 includes a round table 30 and a first screw 31 disposed on a lower bottom face of the round table 30. A limit protrusion 300 that is able to be movably engaged with the hexagonal hole 121 is disposed on an outer sidewall of the round table 30.

### Embodiment 3

Differences between this embodiment and Embodiment 2 are as follows.

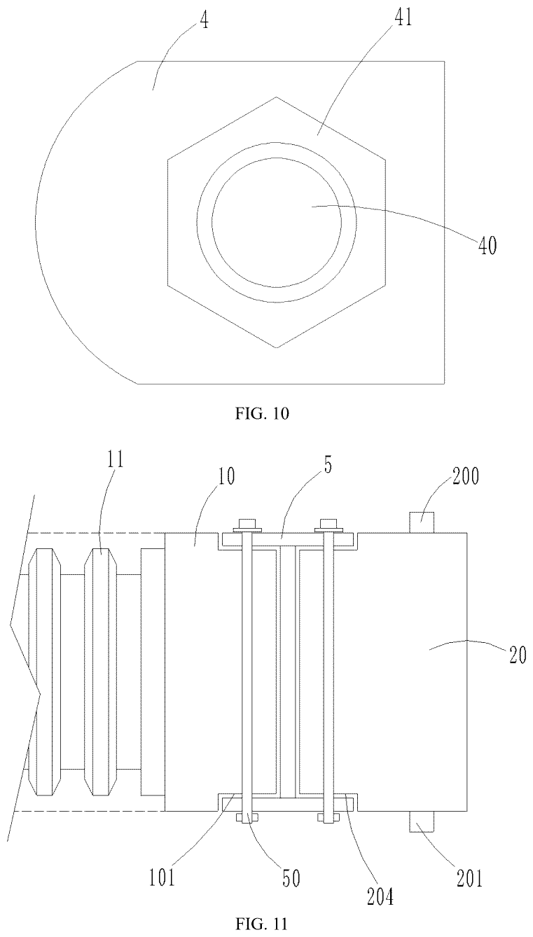

As shown in FIG. 10, a gasket 4 sleeved on the first screw 31 at a corresponding position is disposed between two adjacent lug structures 12. A communication hole 40 runs through the gasket 4, and hexagonal bosses 41 that are able to be movably engaged with the hexagonal holes 121 are disposed on the gasket 4 and located at upper and lower ends of the communication hole 40.

### Embodiment 4

Differences between this embodiment and Embodiment 3 are as follows.

As shown in FIG. 5, FIG. 7 and FIG. 8, a first sawtooth portion 13 is circumferentially disposed on an outer sidewall of the square frame 7, and a second sawtooth portion 202 that is able to be movably engaged with the first sawtooth portion 13 is disposed on an inner sidewall of the first buoyancy module 20. Third sawtooth portions 203 are disposed at both ends of the first buoyancy module 20, and fourth sawtooth portions 210 that are able to be movably engaged with the third sawtooth portions 203 are disposed at both ends of the second buoyancy module 21.

### Embodiment 5

Differences between this embodiment and Embodiment 4 are as follows.

As shown in FIG. 8 and FIG. 11, each of the lug structures 12 is respectively slidably engaged with the square frame 10, the first buoyancy module 20, and the second buoyancy module 21 at corresponding positions by using sliding guide rods 122. A first clamping groove 101 is disposed on a sidewall of the square frame 10. A second clamping groove 204 is disposed on a sidewall of the first buoyancy module 20, and an H-shaped retainer 5 is movably clamped between the first clamping groove 101 and the second clamping groove 204 at corresponding positions for clamping. The H-shaped retainer 5 is respectively fixedly connected to the first clamping groove 101 and the second clamping groove 204 by using second screws 50.

### Embodiment 6

Differences between this embodiment and Embodiment 5 are as follows.

As shown in FIG. 4, the drain pipes 201 on each of the first buoyancy modules 20 are in communication by using communication pipes 22.

### Embodiment 7

Differences between this embodiment and Embodiment 6 are as follows.

As shown in FIG. 3, a fence structure 6 is disposed on an end face of the habitat platform unit. The fence structures 6 are movably inserted in upper end faces of the square frames 10 that are spliced together in a circumferential direction.

1. A combined habitat platform for rapidly constructing a bird microhabitat, wherein the platform comprises a plurality of habitat platform units; each of the habitat platform units comprises several mutually connected main body splicing units (1), buoyant units (2) disposed on outer sidewalls of the main body splicing units (1), fixed bolts (3) configured to connect the main body splicing units (1) and the buoyant units (2), and a vegetation layer disposed on upper end faces of the main body splicing units (1);
the main body splicing unit (1) comprises a square frame (10) and several buoyant columns (11) equally distributed inside the square frame (10); lug structures (12) are disposed at four corner positions of the square frame (10), and a mounting hole (120) runs through each of the lug structures (12);
the buoyancy unit (2) comprises first buoyancy modules (20) disposed on sides of the square frame (10) and second buoyancy modules (21) disposed at four corner positions of the square frame (10); both ends of the first buoyancy module (20) are provided with the lug structures (12), and the second buoyancy module (21) is also provided with the lug structures (12); the lug structures (12) on the adjacent square frame (10), first buoyancy module (20) and second buoyancy modules (21) overlap with one another, and the mutually overlapped lug structures (12) are connected and fixed by using the fixed bolts (3); a water injection pipe (200) is disposed on an upper end face of each of the first buoyancy modules (20), and a drain pipe (201) is disposed on a lower bottom face of each of the first buoyancy modules (20);
the vegetation layer comprises a cushion layer paved on the upper end faces of the main body splicing units (1), a substrate paved above the cushion layer, and plants planted on the substrate;
an annular groove (110) is formed in each of the buoyant columns (11);
a first sawtooth portion (14) is circumferentially disposed on an outer sidewall of the square frame (10), and a second sawtooth portion (202) that is able to be movably engaged with the first sawtooth portion (14) is disposed on an inner sidewall of the first buoyancy module (20); third sawtooth portions (203) are disposed at both ends of the first buoyancy module (20), and fourth sawtooth portions (210) that are able to be movably engaged with the third sawtooth portions (203) are disposed at both ends of the second buoyancy module (21);
a rod-shaped joint (100) is disposed on a lower bottom face of each of the square frames (10) ;
each of the lug structures (12) is respectively slidably engaged with the square frame (10), the first buoyancy module (20), and the second buoyancy module (21) at corresponding positions by using sliding guide rods (122); a first clamping groove (101) is disposed on a sidewall of the square frame (10); a second clamping groove (204) is disposed on a sidewall of the first buoyancy module (20), and an H-shaped retainer (5) is movably clamped between the first clamping groove (101) and the second clamping groove (204) at corresponding positions for clamping; and the H-shaped retainer (5) is respectively fixedly connected to the first clamping groove (101) and the second clamping groove (204) by using second screws (50).

2. The combined habitat platform for rapidly constructing a bird microhabitat according to claim 1, wherein hexagonal holes (121) are disposed inside the lug structure (12) and formed in upper and lower ends of the mounting hole (120); the fixed bolt (3) comprises a round table (30) and a first screw (31) disposed on a lower bottom face of the round table (30); and a limit protrusion (300) that is able to be movably engaged with the hexagonal hole (121) is disposed on an outer sidewall of the round table (30).

3. The combined habitat platform for rapidly constructing a bird microhabitat according to claim 1, wherein a gasket (4) sleeved on the first screw (31) at a corresponding position is disposed between two adjacent lug structures (12); and a communication hole (40) runs through the gasket (4), and hexagonal bosses (41) that are able to be movably engaged with the hexagonal holes (121) are disposed on the gasket (4) and located at upper and lower ends of the communication hole (40).
